(19) United States
(12) Patent Application Publication
(10) Pub. No.: US 2026/0297437 A1
(43) Pub. Date: Oct. 1, 2026

(54) BIOBASED MULTIFUNCTIONAL ADDITIVES FOR HYDROCARBON DESALTING

(71) Applicant: Solugen, Inc., Houston, TX (US)

(72) Inventors: Kimchi Phan, Houston, TX (US); Jason Helander, Richmond, TX (US); Jun Su An, Houston, TX (US); LoongYi Tan, Bellaire, TX (US); Matheus Paes Paschoalino, Orlando, FL (US); Joe D. Gutierrez, Missouri City, TX (US); Tanner Cox, Seabrook, TX (US); JiHye Kim, Sugar Land, TX (US); Chris Arceo, Houston, TX (US)

(73) Assignee: Solugen, Inc., Houston, TX (US)

(21) Appl. No.: 19/478,701

(22) PCT Filed: May 3, 2024
(86) PCT No.: PCT/US2024/027741

§ 371 Date: Oct. 24, 2025

Related U.S. Application Data
(60) Provisional application No. 63/499,902, filed on May 3, 2023.
(60) Provisional application No. 63/582,008, filed on Sep. 12, 2023.

(51) Int. Cl. C10G 17/02; C11B 3/04

(52) U.S. Cl. CPC C10G 17/02; C11B 3/04; C10G 2300/1033; C10G 2300/205

(57) ABSTRACT

A desalting composition including a sugar oxidation product and least one compound selected from the group consisting of chelating agents, aliphatic alpha-hydroxy acids, surfactants, and combinations thereof. A method of desalting a nonaqueous fluid comprising contacting the nonaqueous fluid with a treatment composition comprising a sugar oxidation product and least one compound selected from the group consisting of chelating agents, aliphatic alpha-hydroxy acids, surfactants, and combinations thereof to form a mixture; and allowing the mixture to form an aqueous phase and nonaqueous phase wherein the nonaqueous phase has a reduced metal concentration relative to the nonaqueous fluid.

### CROSS-REFERENCE TO RELATED APPLICATIONS

This application is a 35 U.S.C. § 371 national stage application of PCT/US2024/027741 filed May 3, 2024, and entitled “Biobased Multifunctional Additives for Hydrocarbon Desalting,” which claims benefit of U.S. Provisional Application Ser. No. 63/449,902 filed May 3, 2023, and entitled “Biobased Multifunctional Additives for Hydrocarbon Desalting,” and U.S. Provisional Application Ser. No. 63/582,008 filed Sep. 12, 2023, and entitled “Biobased Multifunctional Additives for Hydrocarbon Desalting,” each of which is hereby incorporated herein by reference in its entirety for all purposes.

### FIELD

The present disclosure relates generally to biobased additives. More particularly, the present disclosure relates to biobased additives for desalting nonaqueous fluids.

### BACKGROUND

Crude oils are complex mixtures obtained from many parts of the world and all crude oils contain a dilute dispersion/emulsion of ultrafine water droplets with a variety of salts, solids and metals. These impurities can adversely impact the equipment crude oils are contacted with resulting in shortened equipment lifetimes and reduced equipment reliability. To mitigate these adverse effects the crude oil is desalted.

Desalting typically involves multiple steps such as dilution of the crude oil with the addition of clean water and agitation of the diluted water and oil mixture which allows for a portion of the salt to transfer from the crude oil to the water phase. The emulsion is then passed through a desalter, which separates the emulsion into two separate layers, an aqueous layer and a layer of desalted crude oil. This process can be repeated any number of times until the amount of salts is reduced to some desired level.

The effective removal of salts, especially those containing corrosive cations, may be facilitated by the inclusion of agents, termed desalting agents, that can capture of these cations. An ongoing need exists for novel desalting agents that facilitate the reduction of salts from nonaqueous fluids.

### SUMMARY

Disclosed herein is a desalting composition comprising a sugar oxidation product and least one compound selected from the group consisting of chelating agents, aliphatic alpha-hydroxy acids, surfactants, and combinations thereof.

Also disclosed herein is a method of desalting a nonaqueous fluid comprising contacting the nonaqueous fluid with a treatment composition comprising a sugar oxidation product and least one compound selected from the group consisting of chelating agents, aliphatic alpha-hydroxy acids, surfactants, and combinations thereof to form a mixture; and allowing the mixture to form an aqueous phase and nonaqueous phase wherein the nonaqueous phase has a reduced metal concentration relative to the nonaqueous fluid.

### BRIEF DESCRIPTION OF THE FIGURES

The following figures form part of the present specification and is included to further demonstrate certain aspects of the present disclosure. The subject matter of the present disclosure may be better understood by reference to the figure in combination with the detailed description of specific aspects presented herein.

FIG. 1 is a bar graph the amount of water dropped as a function of sample type.

FIG. 2 is a bar graph of the iron concentration in a nonaqueous fluid as a function of sample type.

FIG. 3 is a bar graph of the iron concentration in a nonaqueous fluid treated with the indicated mixtures of gluconic acid and glucaric acid.

FIG. 4 is a bar graph of the iron concentration in a nonaqueous fluid treated with the indicated samples.

FIG. 5 is a bar graph comparing the amount of metal removed from crude oil using composition comprising a DAC of the present disclosure.

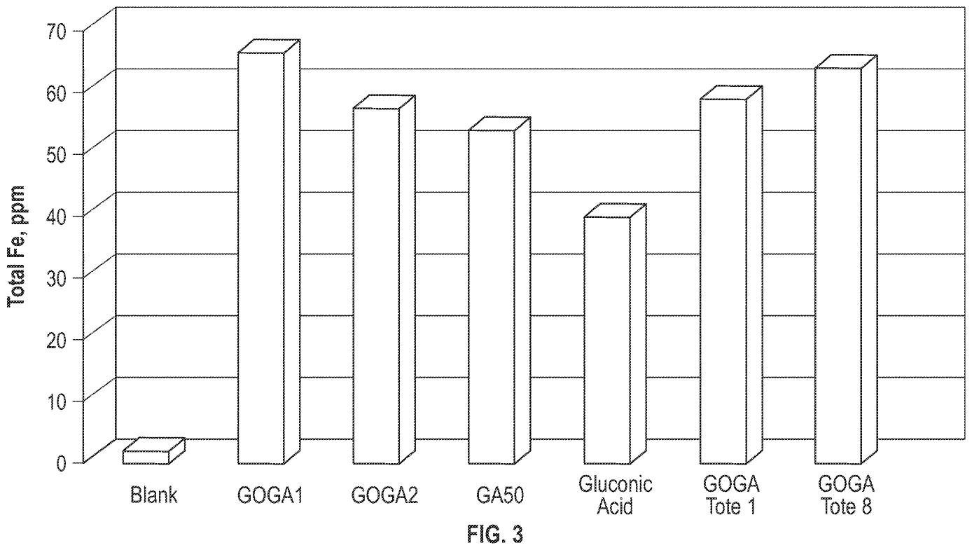

FIG. 3 is a bar graph depicting the total amount of dissolved iron, calcium and amount of metals removed as a function of sample.

FIG. 7 is a bar graph depicting the total amount of dissolved iron, calcium and amount of metals removed for samples containing glyoxal, glycolic acid and lactic acid.

FIG. 8 is a bar graph depicting the amount of remaining iron as a function of sample type.

FIG. 9 is a bar graph depicting the amount of remaining calcium as a function of sample type.

FIG. 10 is a bar graph depicting the amount of remaining phosphorus as a function of sample type.

### DETAILED DESCRIPTION

Disclosed herein is a desalting agent composition (DAC) for use in the reduction of salts from a nonaqueous fluid. In one or more aspects, the DAC comprises a sugar oxidation product (SOP). Additionally, the DAC comprises at least one other compound that facilitates the removal of salts from the nonaqueous fluid. For example, the DAC may comprise at least one compound selected from the group consisting of chelating agents, aliphatic alpha-hydroxy acids, surfactants, and combinations thereof.

In one or more aspects, SOPs suitable for use in the present disclosure comprise aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof or combinations thereof. In an aspect, the SOP comprises a mixture of gluconic acid, glucaric acid, glyoxal, or salts thereof.

In an aspect, an SOP suitable for use in the present disclosure comprises less than about 5 wt. % maltose, maltotriose, fructose, higher molecular weight polysaccharides, oxidation products thereof, or combinations thereof based on the total weight of the sugar oxidation product.

In one or more aspects, the SOP comprises a countercation. Suitable countercations include an alkali metal (Group I) or alkali earth metal (Group II). For example, the cation counterpart may comprise sodium, potassium, calcium, ammonium, or combinations thereof. In one or more aspects, the salt-free (or fully acidified) SOP is used.

In one or more aspects, the SOP may be present in the DAC in an amount ranging from about 0.01 weight percent (wt. %) to about 80 wt. %, alternatively from about 0.01 wt. % to about 10 wt. %, alternatively from about 20 wt. % to about 80 wt. % or alternatively from about 1 wt. % to about 30 wt. % based on the total weight of the DAC. In one or more aspects, the SOP may be present in the DAC in a ratio dependent upon the amount of hydrocarbon and/or foulants to be desalted. For example, the DAC may comprise a cationic foulant such as a corrosive cation. In such aspects, the SOP may be in an amount that provides a stoichiometric ratio of SOP:cationic foulant of from about 0.1 to about 10, in other words 0.1 part SOP to 10 parts cationic foulant. Alternatively, the stoichiometric ratio of SOP:cationic foulant is from about 0.1 to about 2 or alternatively from about 0.5 to about 10.

Alternatively, the SOP may be present in the DAC such that the SOP is in an amount ranging from about 0.1 weight percent (wt. %) to about 30 wt. %, alternatively from about 0.01 wt. % to about 10 wt. %, or alternatively from about 1 wt. % to about 30 wt. %, or alternatively from about 0.5 wt. % to about 5 wt. % based on the total weight of the fluid to be treated.

In one or more aspects, the DAC further comprises a chelating agent. A chelating agent is a chemical compound that can form stable complexes with metal ions by coordinating with them through multiple sites. Chelating agents suitable for use in the present disclosure may be characterized as being stable over the pH range of 5 to 9; should be readily soluble in water; and non-volatile. In one or more aspects, a chelating agent for use in the present disclosure complexes more strongly with corrosion metal cations (Fe³⁺, Cu²⁺, Ni²⁺) than with hardness cations (Mg²⁺, Ca²⁺). Specifically, a chelating agent for use in the present disclosure has a stability constant, K, that is higher for corrosion metal cations than for hardness cations. The stability constant is a measure of the affinity of the complexing agent for a particular metal where a high value for K means a high affinity for chelation of the metal.

In one or more aspects, the chelating agent comprises aliphatic alpha-amino carboxylic acids, aminophosphonic acids, phosphonates, metallated phosphonates, ethylenediaminetetraacetic acid (EDTA), nitrilotriacetic acid (NTA), methylglycinediacetic acid (MGDA), glutamic acid N,N-diacetic acid (GLDA), ethylenediamine-N,N′-disuccinic acid (EDDS), diethylenetriaminepentaacetic acid (DTPA), hydroxyethylethylenediaminetriacetic acid (HEDTA), ethanoldiglycine (EDG), hydroxyethylidenediphosphonic·isocitric acid, ethylenediaminetetra(methylenephosphonic acid), hexamethylenediaminetetra(methylenephosphonic acid), nitrilotris(methylenephosphonic acid); hydroxyethylethylenediaminetriacetic acid, or combinations thereof.

The chelating agent may be present in the DAC in an amount ranging from about 0.01 wt. % to about 80 wt. %, alternatively from about 0.01 wt. % to about 10 wt. %, alternatively from about 20 wt. % to about 80 wt. % or alternatively from about 1 wt. % to about 30 wt. % based on the total weight of the DAC.

In one or more aspects, the DAC comprises one or more aliphatic alpha-hydroxy acids. Nonlimiting examples one or more aliphatic alpha-hydroxy acids suitable for use in the DAC include methanonic acid, ethanoic acid, sulfamic acid, sulfonic acid, propanoic acid, benzoic acid, acrylic acid, lactic acid, pyruvic acid, butyric acid, succinic acid, fumaric acid, malic acid, citric acid, acetic acid, mucic acid, glucoheptonic acid, galactonic acid, guluronic acid, sorbitol, mannitol, or combinations thereof.

An aliphatic alpha-hydroxy acid may be present in the DAC singularly or in combination in an amount ranging from about 0.01 wt. % to about 80 wt. %, additionally or alternatively, from about 0.01 wt. % to about 10 wt. %, additionally or alternatively, from about 20 wt. % to about 80 wt. % or, additionally or alternatively, from about 1 wt. % to about 30 wt. % based on the total weight of the DAC.

In one or more aspects, the DAC comprises a surfactant which may facilitate the water/oil separation during desalting. Nonlimiting examples of surfactants suitable for use in the DAC include quaternary ammonium compounds such didecyl dimethyl ammonium chloride (DDAC)-containing compounds, alkyl dimethyl benzyl ammonium chloride (ADBAC)-containing compounds, ammonium decyl ether sulfate, lauramine oxide, sodium alpha olefin sulfonates, lauryl hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, and combinations thereof.

A surfactant may be present in the DAC in an amount ranging from about 0.01 wt. % to about 80 wt. %, alternatively from about 0.01 wt. % to about 10 wt. %, alternatively from about 20 wt. % to about 80 wt. % or alternatively from about 1 wt. % to about 30 wt. % based on the total weight of the DAC.

In one or more aspects, the DAC comprises a strong base. The strong base may function to raise the pH (e.g., greater than about 8) to avoid the corrosion in the system. Nonlimiting examples of strong bases suitable for use in the present disclosure include sodium hydroxide (NaOH), calcium hydroxide (Ca(OH)₂) potassium hydroxide (KOH), barium hydroxide (Ba(OH)₂), and lithium hydroxide (LiOH). The base may be present in the DAC in an amount ranging from about 0.1 wt. % to about 10 wt. %, alternatively from about 1 wt. % to about 10 wt. % alternatively from about 0.5 wt. % to about 8 wt. % or alternatively from about 5 wt. % to 10 wt. % based on the total of the DAC.

In some aspects, the DAC further comprises a solvent. Solvent which can be used with the DAC include without limitation water, hydrocarbons, halogenated hydrocarbons, ethers, carbonates, esters, ketones, aldehydes, alcohols, nitriles and combinations thereof. Polar solvents which can be utilized include without limitation water ethers, carbonates, esters, ketones, aldehydes, alcohols, nitriles, and mixtures thereof. A solvent may be present in the DAC in any amount suitable to meet one or more process and/or user goals. In some aspects, the solvent constitutes the remainder of the DAC once all other components are accounted for.

A DAC can be prepared using any suitable method. In aspects, a method of the present disclosure comprises mixing components (e.g., SOP, quaternary ammonium compound, aliphatic α-hydroxy acid, solvent) using mixing equipment (e.g., a mixer, a blender). Mixing components of the DAC can comprise one or more steps. For example, mixing the components of DAC can comprise forming a dry mixture, the dry mixture can be combined with a solvent (e.g., water) until a homogeneous mixture is formed. Any container(s) that is compatible with the components and has sufficient space can be used for mixing.

In one or more aspects, the DAC comprises a mixture of gluconic acid and glucaric acid present in molar ratios of gluconic acid:glucaric acid ranging from about 1:1 to about 2:1 or ranging from 4:1 to 0.25:1.

In one or more aspects, the DAC comprises gluconic acid, glucaric acid and one or more aliphatic alpha-hydroxy acids. For example, the aliphatic alpha-hydroxy acids may comprise citric acid, lactic acid or a combination thereof. In such aspects, the molar ratio of gluconic acid:glucaric:one or more aliphatic alpha-hydroxy acids may range from about 0.5:0.5:1 to about 1:1:1.

In one or more aspects, the DAC comprise gluconic acid and one or more aliphatic alpha-hydroxy acids. In such aspects, the molar ratio of gluconic acid:one or more aliphatic alpha-hydroxy acids may range from about 0.2:1 to about 1:1.

In one or more aspects, the DAC comprise glucaric acid and one or more aliphatic alpha-hydroxy acids. In such aspects, the molar ratio of glucaric acid:one or more aliphatic alpha-hydroxy acids may range from about 0.2:1 to about 1:1.

In one or more aspects, the DAC comprises gluconic acid, and one or more quaternary ammonium compounds. In such aspects, the molar ratio of gluconic acid:one or more quaternary ammonium compounds may range from about 1:9 to about 9:1, or 0.5:1 to 4:1.

In one or more aspects, the DAC comprise glucaric acid and one or more quaternary ammonium compounds. In such aspects, glucaric acid is present in an amount of about 10 wt. % while the one or more quaternary ammonium compounds is present in an amount of about 90% based on the total weight of the DAC. Alternatively, glucaric acid is present in an amount of about 90 wt. % while the one or more quaternary ammonium compounds is present in an amount of about 10% based on the total weight of the DAC.

In one or more aspects, the DAC comprises glyoxal. In such aspects, glyoxal is present in the DAC in an amount of from about 0.5 wt. % to about 50 wt. %, alternatively from about 5 wt. % to about 40 wt. %, alternatively from about 2 wt. % to about 20 wt. % or alternatively from about 0.5 wt. % to about 15 wt. % based on the total weight of the DAC.

Nonlimiting examples of nonaqueous fluids that may be subjected to desalting using a DAC of the type disclosed herein include slop oil, crude oil, refined oil products, fuels, gasoline, diesel, kerosene, heating oil, olefins, alkanes, paraffins, alkenes, aromatics, mixtures containing benzene, toluene, and the three xylene isomers (BTX), alcohols such as ethanol, bio-based oils, vegetable oils such as soybean, corn, rapeseed, canola, safflower, sunflower, nut oils, palm oil, citrus oils, animal oils, rendered animal fats and combinations thereof. In some aspects, the nonaqueous fluid is a water-miscible solvent such as alcohol.

In one or more aspects, the DAC may be effective to reduce the amount of metals present in the nonaqueous fluid (e.g., the metal cation component of a salt). Nonlimiting examples of metals that may be present in a nonaqueous fluid include calcium, magnesium, iron, copper, cobalt, vanadium, aluminum, and combinations thereof. Not intending to be bound by theory, a reduction in metals present in a nonaqueous fluid can occur due to chelation of the metals and preferential partitioning of the chelated metal into the aqueous phase.

Additionally, or alternatively, the DAC may also be effective to solubilize any metals present as solids, for example, by chelating the metals to increase the solubility of the components in an aqueous phase. In some aspects, the DAC may be used to treat a nonaqueous fluid having a metal content in amounts ranging from about 10 ppm to about 100,000 ppm, alternatively from about 10 ppm to about 1000 ppm, alternatively from about 100 ppm to about 30,000 ppm or alternatively from about 1000 ppm to about 100,000 ppm based on a variety of factors such as hydrocarbon sources, process conditions, catalyst used, and other factors.

In one or more aspects, a DAC enhances the aqueous/non-aqueous separation of an emulsion. In one or more aspects, contacting a nonaqueous fluid with a DAC may result in the formation an aqueous phase and a nonaqueous phase. In one or more aspects, the DAC may be contacted directly with the nonaqueous fluid before being contacted with an aqueous fluid and treated as disclosed herein. In alternative aspects, the DAC is included with an aqueous fluid to form an aqueous mixture that is subsequently contacted with the nonaqueous fluid.

The nonaqueous phase may have a depleted salt content when compared to the salt content in the aqueous phase. For example, in some aspects, contacting of a nonaqueous fluid with the DAC creates a reduction of salts/metals in the nonaqueous fluid. In additional or alternative aspects, the DAC is contacted with a nonaqueous water-miscible fluid. In such aspects, the DAC may facilitate the formation of (i) salt precipitates and (ii) two phases. In such aspects, a solid phase containing the precipitated salts and a nonaqueous water-miscible fluid containing a reduced salt content is formed. In one or more aspects, the DAC reduces the amount of salts and/or metals present in the nonaqueous fluid and/or nonaqueous water-miscible fluid by from about 5% to about 90%, alternatively from about 10% to about 90%, alternatively from about 5% to about 20%, alternatively from about 50% to about 70% or alternatively from about 0.001% to about 10%.

In one or more aspects, an emulsion may be formed and/or an emulsion may be present as a component within the nonaqueous fluid. In some aspects, a demulsifier may be introduced to the mixture of DAC and nonaqueous fluid. Any demulsifier compatible with the other components of the mixture may be used. Nonlimiting examples of demulsifiers include acid catalyzed phenol-formaldehyde resins, base catalyzed phenol-formaldehyde resins, epoxy resins, polyethyleneimines, polyamines, diepoxides, polyols, dendrimer, silicon particles, silica, alumina, and combinations thereof. In such aspects, the demulsifiers are present in the DAC in an amount ranging from about 0.5 ppm to about 1000 ppm, alternatively from about 2 ppm to about 500 ppm, alternatively from about 0.5 ppm to about 100 ppm or alternatively from about 5 ppm to about 200 ppm.

Advantageously, the DAC may additionally function as a corrosion inhibitor. In an aspect, the DAC may reduce corrosion to a system it is introduced to an amount that is from about 10% to about 90%, alternatively from about 20% to about 80% or alternatively from about 30% to about 80% when compared to the amount of corrosion formed in the absence of the DAC.

The present disclosure outlines a composition (i.e., the DAC) and methods to reduce the metal content in nonaqueous fluids. The presently disclosed process utilizes a SOP prepared via a chemienzymatic process using dextrose as a starting feedstock.

In one or more aspects, the DAC and methods disclosed herein are useful for the desalting of nonaqueous fluids in applications such as refineries. Additionally, the DAC and methods disclosed herein may be used in the reduction in the concentration of or removal of metals and/or metal salts from any nonaqueous solution such as solvents. The reduction in the concentration or removal of metal or metal salts from nonaqueous solutions may be accompanied by a decrease in the corrosive nature of the nonaqueous solution.

### ADDITIONAL DISCLOSURE

A first aspect which is a desalting composition comprising a sugar oxidation product and least one compound selected from the group consisting of chelating agents, aliphatic alpha-hydroxy acids, surfactants, and combinations thereof.

A second aspect which is the composition of the first aspect wherein the sugar oxidation product comprises aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof or combinations thereof.

A third aspect which is the composition of any of the first through second aspects wherein the sugar oxidation product comprises gluconic acid, glucaric acid, glyoxal, salts thereof or combinations thereof.

A fourth aspect which is the composition of any of the first through third aspects, wherein the sugar oxidation product comprises a mixture of gluconic acid and glucaric acid.

A fifth aspect which is the composition of the fourth aspect wherein the mixture has a ratio of gluconic acid:glucaric acid ranging from 4:1 to 0.25:1.

A sixth aspect which is the composition of any of the first through fifth aspects wherein the chelating agent comprises aliphatic alpha-hydroxy acids, aliphatic alpha-amino carboxylic acids, aminophosphonic acids, phosphonates, metallated phosphonates, ethylenediaminetetraacetic acid (EDTA), nitrilotriacetic acid (NTA), methylglycinediacetic acid (MGDA), glutamic acid N,N-diacetic acid (GLDA), ethylenediamine-N,N′-disuccinic acid (EDDS), diethylenetriaminepentaacetic acid (DTPA), hydroxyethylethylenediaminetriacetic acid (HEDTA), ethanoldiglycine (EDG), hydroxyethylidenediphosphonic·isocitric acid, ethylenediaminetetra(methylenephosphonic acid), hexamethylenediaminetetra(methylenephosphonic acid), nitrilotris(methylenephosphonic acid); hydroxyethylethylenediaminetriacetic acid, or combinations thereof.

A seventh aspect which is the composition of any of the first through sixth aspects wherein the one or more aliphatic alpha-hydroxy acids comprise methanonic acid, ethanoic acid, sulfamic acid, sulfonic acid, propanoic acid, benzoic acid, acrylic acid, lactic acid, pyruvic acid, butyric acid, succinic acid, fumaric acid, malic acid, citric acid, acetic acid, mucic acid, glucoheptonic acid, galactonic acid, guluronic acid, sorbitol, mannitol, or combinations thereof.

An eighth aspect which is the composition of any of the first through seventh aspects wherein the surfactant comprises didecyl dimethyl ammonium chloride (DDAC)-containing compounds, alkyl dimethyl benzyl ammonium chloride (ADBAC)-containing compounds, ammonium decyl ether sulfate, lauramine oxide, sodium alpha olefin sulfonates, laurl hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, or combinations thereof.

A ninth aspect which is the composition of any of the first through eighth aspects comprising a solvent.

A tenth aspect which is the composition of the ninth aspect wherein the solvent comprises water, hydrocarbons, halogenated hydrocarbons, ethers, carbonates, esters, ketones, aldehydes, alcohols, nitriles and combinations thereof.

An eleventh aspect which is a method of desalting a nonaqueous fluid comprising contacting the nonaqueous fluid with a treatment composition comprising a sugar oxidation product and least one compound selected from the group consisting of chelating agents, aliphatic alpha-hydroxy acids, surfactants, and combinations thereof to form a mixture; and allowing the mixture to form an aqueous phase and nonaqueous phase wherein the nonaqueous phase has a reduced metal concentration relative to the nonaqueous fluid.

A twelfth aspect which is the method of the eleventh aspect wherein the nonaqueous fluid comprises slop oil, crude oil, refined oil products, fuels, gasoline, diesel, kerosene, heating oil, olefins, alkanes, paraffins, alkenes, aromatics, benzene, toluene, xylene isomers, alcohols, bio-derived oils, soybean, corn, rapeseed, canola, safflower, sunflower, nut oils, palm oil, citrus oils, animal fats, animal rendered oils, or combinations thereof.

A thirteenth aspect which is the method of any of the eleventh through twelfth aspects, wherein the sugar oxidation product comprises gluconic acid, glucaric acid, glyoxal, salts thereof or combinations thereof.

A fourteenth aspect which is the method of any of the eleventh through thirteenth aspects wherein the sugar oxidation product comprises a mixture of gluconic acid and glucaric acid.

A fifteenth aspect which is the method of the fourteenth aspect wherein the mixture has a ratio of gluconic acid:glucaric acid ranging from 4:1 to 0.25:1.

A sixteenth aspect which is the method of any of the eleventh through fifteenth aspects wherein the chelating agent comprises aliphatic alpha-hydroxy acids, aliphatic alpha-amino carboxylic acids, aminophosphonic acids, phosphonates, metallated phosphonates, ethylenediaminetetraacetic acid (EDTA), nitrilotriacetic acid (NTA), methylglycinediacetic acid (MGDA), glutamic acid N,N-diacetic acid (GLDA), ethylenediamine-N,N′-disuccinic acid (EDDS), diethylenetriaminepentaacetic acid (DTPA), hydroxyethylethylenediaminetriacetic acid (HEDTA), ethanoldiglycine (EDG), hydroxyethylidenediphosphonic·isocitric acid, ethylenediaminetetra(methylenephosphonic acid), hexamethylenediaminetetra(methylenephosphonic acid), nitrilotris(methylenephosphonic acid); hydroxyethylethylenediaminetriacetic acid, or combinations thereof.

A seventeenth aspect which is the method of any of the eleventh through sixteenth aspects wherein the one or more aliphatic alpha-hydroxy acids comprise methanonic acid, ethanoic acid, sulfamic acid, sulfonic acid, propanoic acid, benzoic acid, acrylic acid, lactic acid, pyruvic acid, butyric acid, succinic acid, fumaric acid, malic acid, citric acid, acetic acid, mucic acid, glucoheptonic acid, galatonic acid, guluronic acid, sorbitol, mannitol, or combinations thereof.

An eighteenth aspect which is the method of any of the eleventh through seventeenth aspects wherein the surfactant comprises didecyl dimethyl ammonium chloride (DDAC)-containing compounds, alkyl dimethyl benzyl ammonium chloride (ADBAC)-containing compounds, ammonium decyl ether sulfate, lauramine oxide, sodium alpha olefin sulfonates, lauryl hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, or combinations thereof.

A nineteenth aspect which is the method of any of the eleventh through eighteenth aspects wherein the treatment composition further comprises a demulsifier.

A twentieth aspect which is the method of any of the eleventh through nineteenth aspects wherein the metal concentration is reduced by from about 0.001% to about 10%.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

The ability of a DAC to act as an emulsion breaker was investigated. The samples listed in Table 1 were prepared.

TABLE 1

| Sample Name | Components |
|---|---|
| GOGA1 and | A mixture having an approximately 1:1 ratio of |
| GOGA2 | gluconicacid:glucaric acid |
| GA50 | A 50% active product with 30 wt. % to 50% wt |
| | glucaric acid |
| Gluconic acid | Gluconic acid |
| GOGA Tote 1 | A mixture having a 2.5 L1 ratio of gluconic |
| | acid:glucaric acid |
| GOGA Tote 8 | A mixture having a 3.41:1 ratio of gluconic |
| | acid:glucaric acid |
| Citric acid | Citric acid |
| Lactic acid | Lactic acid |

A sample which did not contain an emulsion breaker was designated as the blank. A standard prescription bottle test was conducted. Specifically, a crude oil was pretreated with 50 ppm of the indicated sample and heated to 60° C. for one hour. Deionized (DI) water was also pretreated with 3000 ppm of the indicated sample. Prescription bottles were filled with 20 ml of pretreated water and then the pretreated oil was filled to the 100 ml mark for a total of 100 ml of fluid. The bottles were capped then mixed for 30 second using a hand blender until an emulsion formed. The bottles were set aside for 24 hours in the 60° C. water bath to allow the water-oil emulsion to separate. After settling, the separated water was carefully decanted from each bottle and water volumes recorded. The total amount of iron in the separated water was analyzed using X-ray fluorescence (XRF) method. Additional analytical testing on the separated water was carried out using Inductively Coupled Plasma (ICP) to measure the total amount of calcium.

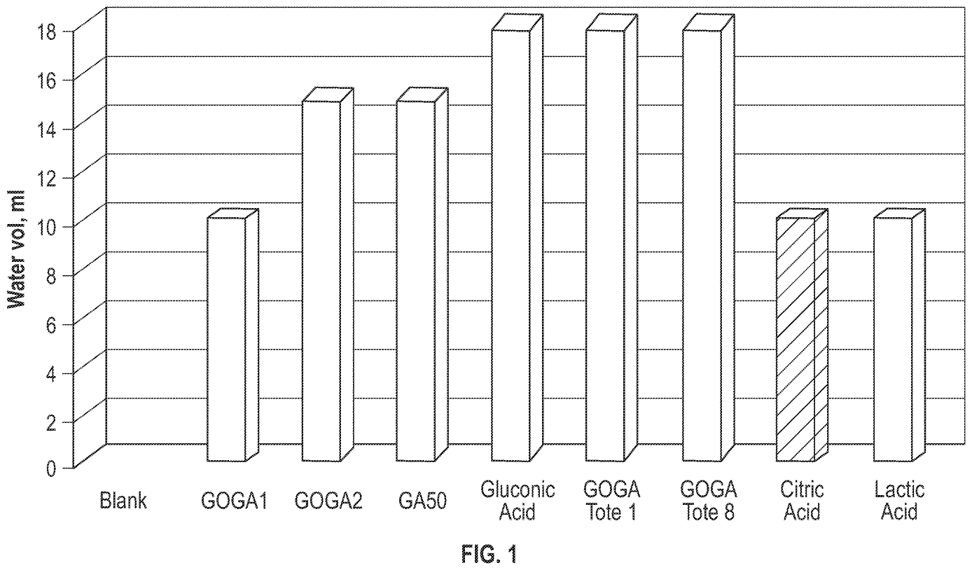

With reference to FIG. 1, a plot of the water separated as a function of sample is presented. All of the DAC samples investigated displayed an increased volume of water released/dropped, indicative of improved emulsion breaking. Based on the volume of water dropped from the emulsion, samples having mixtures of gluconic and glucaric (GOGA) outperformed samples of citric acid or lactic acid.

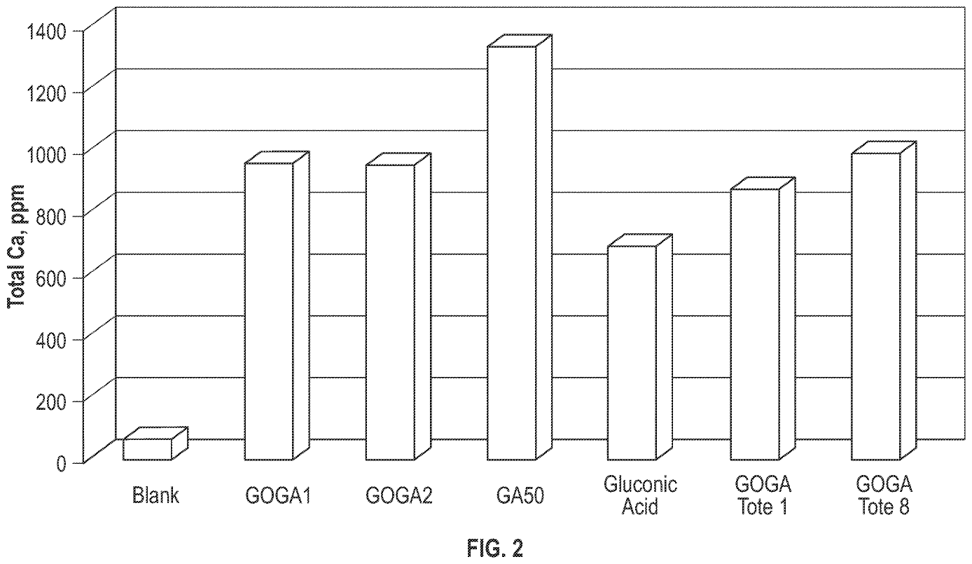

The DCA samples were then analyzed for total calcium content. With reference to FIG. 2, the total calcium content is plotted as a function of sample type. GA50 was the most effective additive for calcium removal. GA50 effectively removed or transferred the calcium from the oil phase to the water phase compared to the other DCA samples tested. Further, GOGA (a mixture of gluconic and glucaric) displayed an increased amount of calcium removal when compared to the amount of calcium removed using gluconic acid alone. These results indicate that the mixture of glucaric acid and gluconic acid exhibits a synergy for calcium metal removal.

The results are similar when analyzing the amount of iron removed by the different samples. With reference to FIG. 3, mixtures of gluconic acid and glucaric acid performed were more effective at removing iron that samples containing gluconic acid alone.

### Example 2

The ability of a DAC to remove aluminum from a nonaqueous fluid was investigated. Specifically, samples were prepared by adding 7 ml of 50% NaOH to adjust the pH of LG60 to pH12 and 16% wash water were used. DACs containing either gluconate (LG60) or a mixture of gluconic acid and glucaric acid (GOGA) along with NaOH were added to the samples and then shaken for 10 minutes and set in a water bath for 2 hours at 50° C. The volume of wash water, olefin and DAC, pH values and amount of Al in the sample are presented in Table 2.

TABLE 2

| Wash | | | Product | DAC | DAC | Normalized | pH of | | Al in |
|---|---|---|---|---|---|---|---|---|---|
| Water | Olefin | | % | Dose | Dose | Active Dose | Wash | pH of | Olefin |
| (ml) | (ml) | DAC | activity | (%) | (ml) | (mL) | Water | precipitants | (mg/Kg) |
| 0 | 70 | N/A | | N/A | N/A | | | | 2930 |
| 14 | 70 | NA | | N/A | N/A | | | 10.38 | 18 |
| 14 | 70 | LG60 + NaOH | 45 | 0.01 | 0.35 | 0.16 | 12.38 | 11.20 | 21.00 |
| 14 | 70 | LG60 + NaOH | 45 | 0.01 | 0.70 | 0.32 | 12.56 | 11.52 | 12.00 |
| 14 | 70 | GOGA + NaOH | 33.75 | 0.01 | 0.35 | 0.12 | 10.76 | 10.71 | 9.00 |
| 14 | 70 | GOGA + NaOH | 33.75 | 0.01 | 0.70 | 0.24 | 10.94 | 10.82 | 5.00 |

As seen in Table 2, the GOGA samples were the most effective in removing aluminum from the olefin. Furthermore, the GOGA samples outperformed the LG sample as seen by the fact that it had the lowest Al concentration in the olefin, but had a less active dose. Since GOGA is less active (but same amount in mL were added), there is higher Al removal on an active basis.

### Example 3

The ability of various compositions comprising a DAC to remove metals from crude oil was investigated. The crude oil that was treated originally contained 1,300 mg/L of iron and was adjusted to contain approximately 500 ppm iron. The incumbent heat, centrifuge, and chemistry (THPS) were marginal, as the iron concentration that was achieved was between 200-400 ppm.

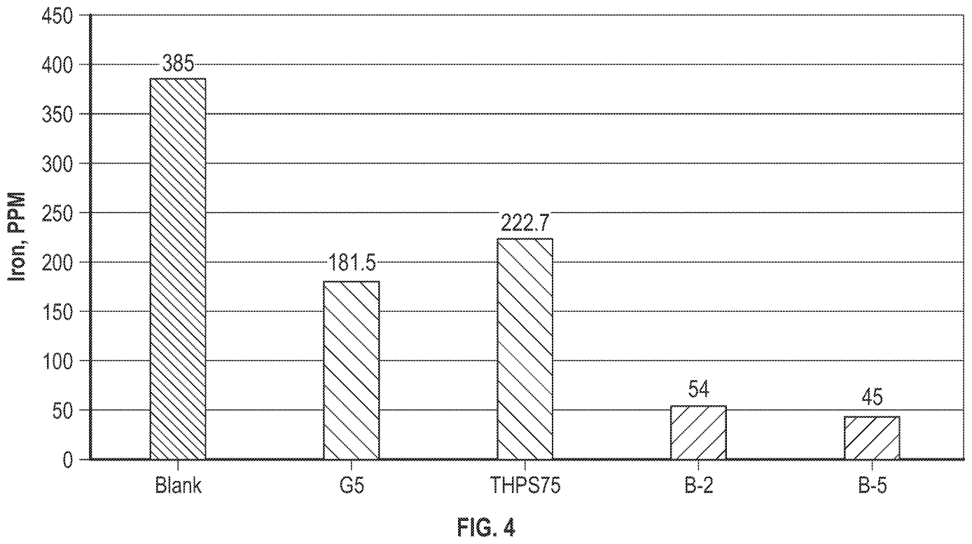

The adjusted crude oil was then contacted with a treatment fluid containing either (i) a 20% wash water comprising a blend of 1:1 sodium gluconate and citric acid, designated G5; (ii) a 75 wt. % tetrakis (hydroxymethyl)phosphonium sulfate solution, designated THPS; (iii) a solution that is a blend of G5 and alkyl dimethyl benzyl ammonium at a 90/10 ratio, designated B2. or (iv) a solution that is a blend of G5 and didecyldimethylammonium chloride in a 90/10 ratio, designated B5. The blank sample was not contacted with a treatment fluid. The results are presented as a graph of the amount of iron in ppm as a function of the sample type, FIG. 4.

With reference to FIG. 4, G5 which contained a blend of sodium gluconate and citric acid outperformed the chelator, THPS. Further, the samples B2 and B5 which were blends of quaternary ammonium compounds and G5, had the highest levels of iron removal.

### Example 4

A DAC containing a blend of organic acids and sugar oxidation products were investigated as iron removal agents. Specifically, sample T5 was a blend of gluconic and citric acid while sample G5 was a blend of sodium gluconate and citric acid.

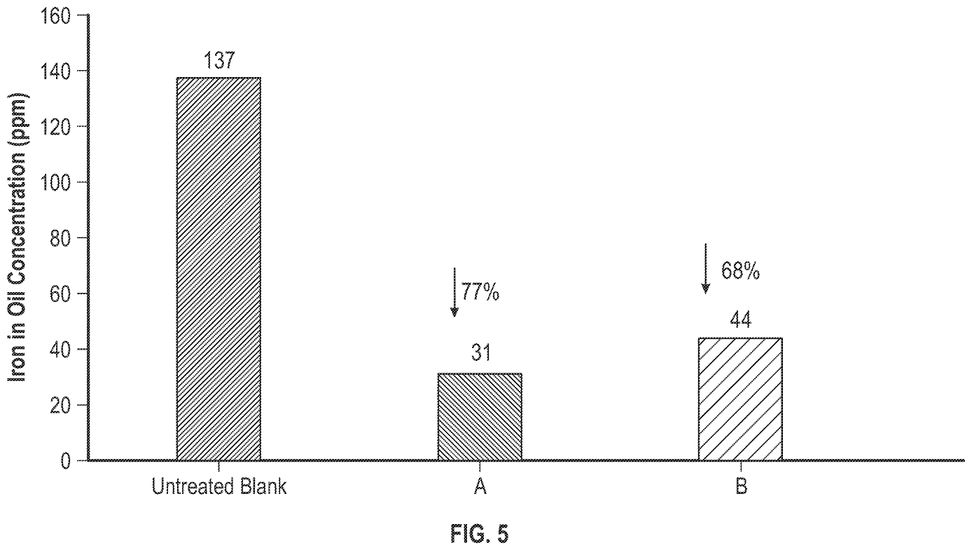

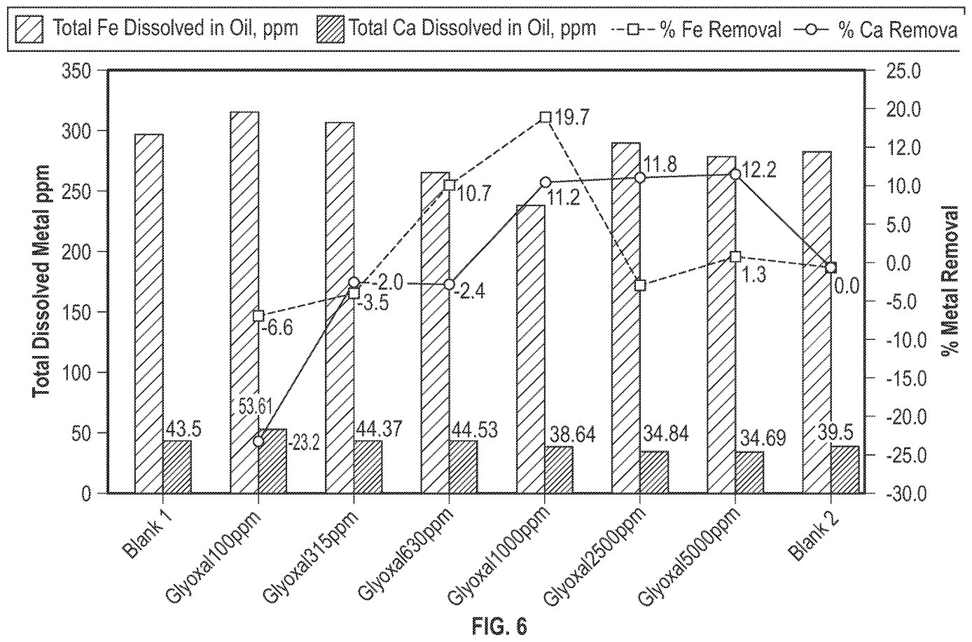

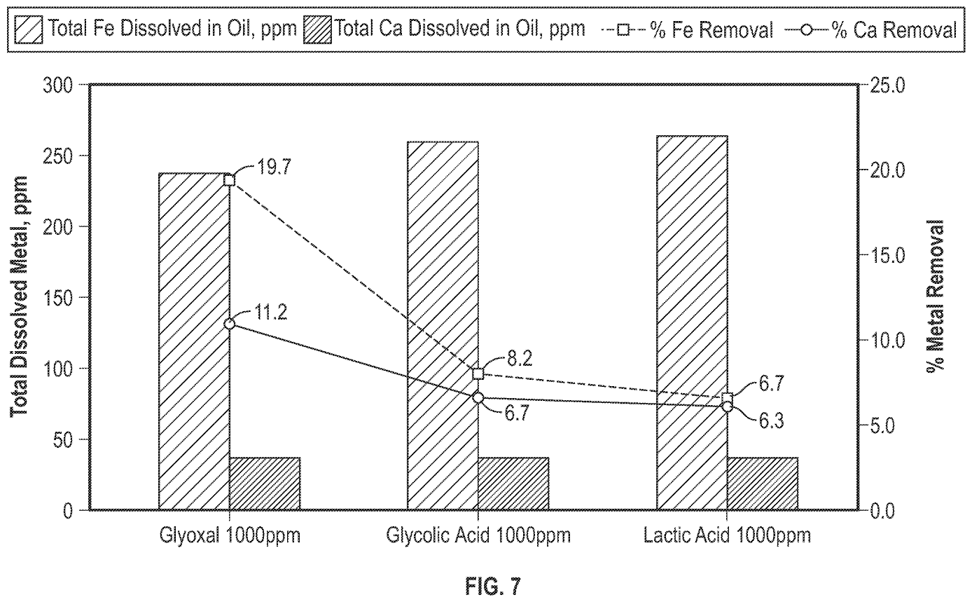

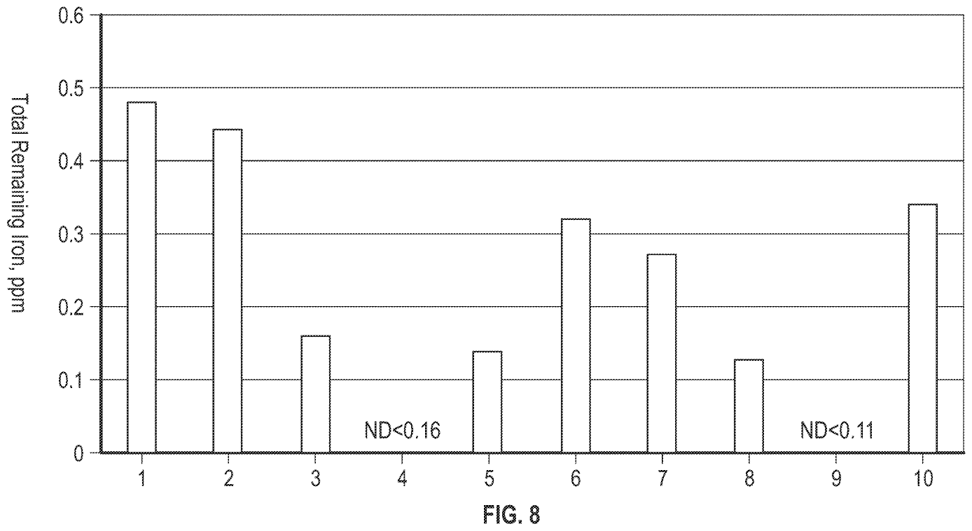

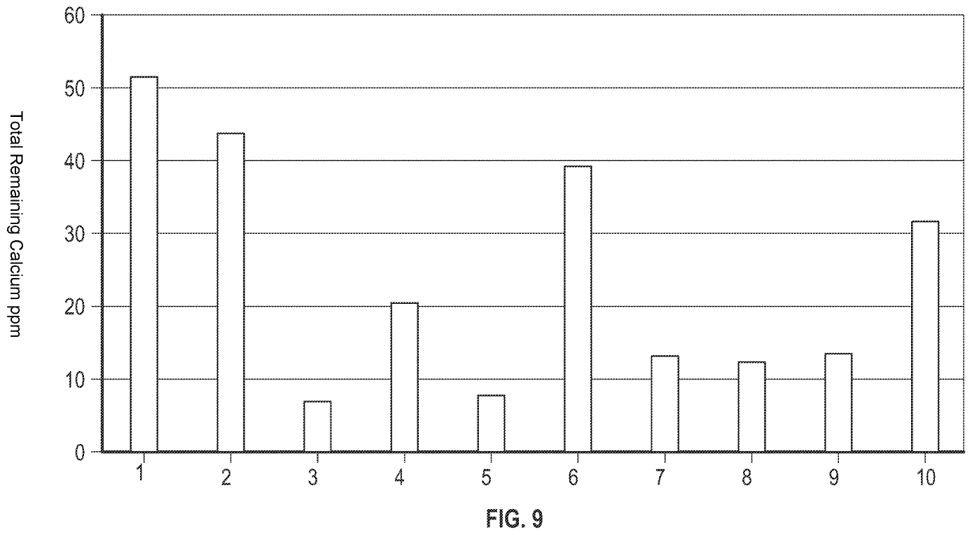

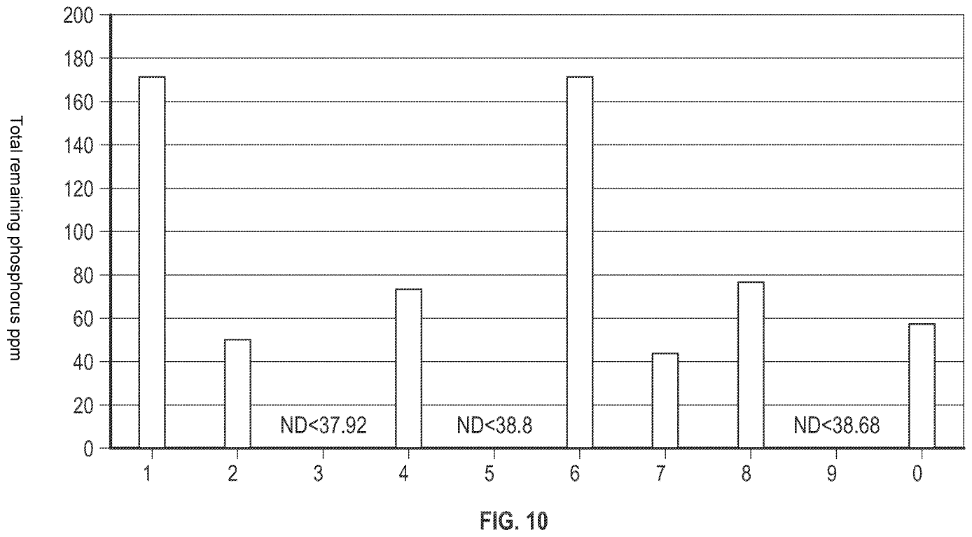

With reference to FIG. 5, use of either G5 or T5 to treat a crude oil sample lead to an increased amount of iron removal, on average a 72% increase, when compared to the untreated sample.

### Example 5

The desalting performance of a DAC comprising glyoxal was investigated. Specifically, crude oil, West Texas crude oil (Fe 3,450 ppm, Ca 628.9 ppm in raw crude) was conditioned at 80° C. for an hour to ensure all solids and paraffins were dissolved back to hydrocarbon phase and mixed well before transferring to prescription bottles. Hot water (50 mL) was added to an empty bottle, before glyoxal, glycolic acid or lactic acid were dosed into the water. The dosage of glyoxal, glycolic acid or lactic acid is indicated in FIG. 6. The samples represented a hot wash water in a desalting process. Then, a mixture was prepared by transferring 50 ml of preheated oil into the bottle with the prepared hot wash water and subsequently into a metal container for mixing. The mixture was blended vigorously using a blender for 30 seconds and then transferred back to the prescription bottle. The prescription bottle was placed in the water bath at 80° C. for 24 hrs. As the prescription bottle sat overnight it entered a static state condition where the sample separated into phases. The sample was then taken from the top phase, just above the oil and water interface, to analyze total amount of calcium and iron using X-ray diffraction Blank 1 and Blank 2 were both samples that had not been contacted with a treatment fluid. The results are depicted in FIG. 6. FIG. 6 has a bar graph depicting (a) the amount of total dissolved iron or calcium per sample and (b) the amount of iron or calcium removed.

Samples containing 1000 ppm glyoxal had the highest percentage calcium and iron removal (calcium 11.2% and iron 19.7%) for the West Texas crude oil. The desalting performance of the sample containing 1000 ppm glyoxal was compared the performance of 1000 ppm glycolic acid or 1000 ppm lactic acid. The samples with glyoxal removed a larger amount metals when compared to samples containing either glycolic acid or lactic acid, FIG. 7.

### Example 6

The ability of a DAC to remove metals from soybean oil was investigated. A crude soybean oil sample was used to mimic the degumming process. A 175 g sample of crude soybean oil was heated to 85° C., then 700 ppm (dry basis) of either gluconic acid, citric acid, GOGA or a mixture thereof was added and the sample mixed with an immersion blender for 1 minute. The content of samples 1-10 are presented in Table 3. The sample was then vigorously agitated with a TEFLON coated stir bar for 1 hour at 85° C. The oil was then cooled to 70° C. and 3.5 ml of deionized water was added and continued to vigorously stir for 30 minutes. The crude soybean oil was then centrifuged for 10 minutes before decanting the sample and the amount of iron, calcium, and phosphorus determined using X-ray fluorescence.

TABLE 3

| | | Dose | | Ca | | % Fe | % Ca | % P |
|---|---|---|---|---|---|---|---|---|
| Product | Sample# | (dry ppm) | Fe (ppm) | (ppm) | P (ppm) | Removed | Removed | Removed |
| Pre-Test Crude | 1 | N/A | 0.48 | 51.42 | 170.8 | N/A | N/A | N/A |
| Soybean Oil | | | | | | | | |
| Water | 2 | 700 | 0.44 | 43.81 | 50.81 | 8.3% | 14.8% | 70.3% |
| 50% Citric Acid | 3 | 700 | 0.16 | 7.1 | ND < 37.92 | 66.7% | 86.2% | >77.8% |
| 50% Gluconic Acid | 4 | 700 | ND < 0.16 | 20.38 | 74.01 | >66.7% | 60.4% | 56.7% |
| GOGA (30.7% | 5 | 700 | 0.14 | 7.91 | ND < 38.8 | 70.8% | 84.6% | >77.3% |
| Gluconic/12.3% | | | | | | | | |
| Glucaric) | | | | | | | | |
| GA50 (12.53% | 6 | 700 | 0.32 | 39.17 | 171.5 | 33.3% | 23.8% | 0% |
| Gluconic/34.89% | | | | | | | | |
| Glucaric) | | | | | | | | |
| 50% Citric/50% | 7 | 700 | 0.27 | 13.24 | 43.61 | 43.8% | 74.3% | 74.5% |
| Gluconic (25/75) | | | | | | | | |
| 50% Citric/50% | 8 | 700 | 0.13 | 12.54 | 77.35 | 72.9% | 75.6% | 54.7% |
| Gluconic (50/50) | | | | | | | | |
| 75% Citric/25% | 9 | 700 | ND < 0.11 | 13.83 | ND < 38.68 | >77.1% | 37.6% | >77.4% |
| Gluconic (75/25) | | | | | | | | |
| 50% Citric/50% | 10 | 700 | 0.34 | 31.55 | 57.95 | 29.2% | 38.6% | 66.1% |
| GOGA (50/50) | | | | | | | | |

Samples 4, 5, 8 and 9 had the largest amount of metal removal. This is depicted in FIG. 8 which is a bar graph of the amount of iron (ppm) remaining as a function of sample. FIG. 9 is a bar graph of the amount of calcium (ppm) remaining as a function of sample; and FIG. 10 is a bar graph of the amount of phosphorous (ppm) remaining as a function of sample.

While aspects of the presently disclosed subject matter have been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the presently disclosed subject matter. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A desalting composition, comprising:
a sugar oxidation product; and
at least one compound selected from the group consisting of chelating agents, aliphatic alpha-hydroxy acids, surfactants, and combinations thereof.

2. The composition of claim 1, wherein the sugar oxidation product comprises aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof or combinations thereof.

3. The composition of claim 1, wherein the sugar oxidation product comprises gluconic acid, glucaric acid, glyoxal, salts thereof or combinations thereof.

4. The composition of claim 1, wherein the sugar oxidation product comprises a mixture of gluconic acid and glucaric acid.

5. The composition of claim 4, wherein the mixture has a ratio of gluconic acid:glucaric acid ranging from 4:1 to 0.25:1.

6. The composition of claim 1, wherein the chelating agent comprises aliphatic alpha-hydroxy acids, aliphatic alpha-amino carboxylic acids, aminophosphonic acids, phosphonates, metallated phosphonates, ethylenediaminetetraacetic acid (EDTA), nitrilotriacetic acid (NTA), methylglycinediacetic acid (MGDA), glutamic acid N,N-diacetic acid (GLDA), ethylenediamine-N,N′-disuccinic acid (EDDS), diethylenetriaminepentaacetic acid (DTPA), hydroxyethylethylenediaminetriacetic acid (HEDTA), ethanoldiglycine (EDG), hydroxyethylidenediphosphonic·isocitric acid, ethylenediaminetetra(methylenephosphonic acid), hexamethylenediaminetetra(methylenephosphonic acid), nitrilotris(methylenephosphonic acid); hydroxyethylethylenediaminetriacetic acid, or combinations thereof.

7. The composition of claim 1, wherein the one or more aliphatic alpha-hydroxy acids comprise methanonic acid, ethanoic acid, sulfamic acid, sulfonic acid, propanoic acid, benzoic acid, acrylic acid, lactic acid, pyruvic acid, butyric acid, succinic acid, fumaric acid, malic acid, citric acid, acetic acid, mucic acid, glucoheptonic acid, galactonic acid, guluronic acid, sorbitol, mannitol, or combinations thereof.

8. The composition of claim 1, wherein the surfactant comprises didecyl dimethyl ammonium chloride (DDAC)-containing compounds, alkyl dimethyl benzyl ammonium chloride (ADBAC)-containing compounds, ammonium decyl ether sulfate, lauramine oxide, sodium alpha olefin sulfonates, lauryl hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, or combinations thereof.

9. The composition of claim 1, further comprising a solvent.

10. The composition of claim 9, wherein the solvent comprises water, hydrocarbons, halogenated hydrocarbons, ethers, carbonates, esters, ketones, aldehydes, alcohols, nitriles and combinations thereof.

11. A method of desalting a nonaqueous fluid comprising contacting the nonaqueous fluid with a treatment composition comprising a sugar oxidation product and least one compound selected from the group consisting of chelating agents, aliphatic alpha-hydroxy acids, surfactants, and combinations thereof to form a mixture; and
allowing the mixture to form an aqueous phase and nonaqueous phase wherein the nonaqueous phase has a reduced metal concentration relative to the nonaqueous fluid.

12. The method of claim 11, wherein the nonaqueous fluid comprises slop oil, crude oil, refined oil products, fuels, gasoline, diesel, kerosene, heating oil, olefins, alkanes, paraffins, alkenes, aromatics, benzene, toluene, xylene isomers, alcohols, bio-derived oils, soybean, corn, rapeseed, canola, safflower, sunflower, nut oils, palm oil, citrus oils, animal fats, animal rendered oils, or combinations thereof.

13. The method of claim 11, wherein the sugar oxidation product comprises gluconic acid, glucaric acid, glyoxal, salts thereof or combinations thereof.

14. The method of claim 11, wherein the sugar oxidation product comprises a mixture of gluconic acid and glucaric acid.

15. The method of claim 14, wherein the mixture has a ratio of gluconic acid:glucaric acid ranging from 4:1 to 0.25:1.

16. The method of claim 11, wherein the chelating agent comprises aliphatic alpha-hydroxy acids, aliphatic alpha-amino carboxylic acids, aminophosphonic acids, phosphonates, metallated phosphonates, ethylenediaminetetraacetic acid (EDTA), nitrilotriacetic acid (NTA), methylglycinediacetic acid (MGDA), glutamic acid N,N-diacetic acid (GLDA), ethylenediamine-N,N′-disuccinic acid (EDDS), diethylenetriaminepentaacetic acid (DTPA), hydroxyethylethylenediaminetriacetic acid (HEDTA), ethanoldiglycine (EDG), hydroxyethylidenediphosphonic·isocitric acid, ethylenediaminetetra(methylenephosphonic acid), hexamethylenediaminetetra(methylenephosphonic acid), nitrilotris(methylenephosphonic acid); hydroxyethylethylenediaminetriacetic acid, or combinations thereof.

17. The method of claim 11, wherein the one or more aliphatic alpha-hydroxy acids comprise methanonic acid, ethanoic acid, sulfamic acid, sulfonic acid, propanoic acid, benzoic acid, acrylic acid, lactic acid, pyruvic acid, butyric acid, succinic acid, fumaric acid, malic acid, citric acid, acetic acid, mucic acid, glucoheptonic acid, galactonic acid, guluronic acid, sorbitol, mannitol, or combinations thereof.

18. The method of claim 11, wherein the surfactant comprises didecyl dimethyl ammonium chloride (DDAC)-containing compounds, alkyl dimethyl benzyl ammonium chloride (ADBAC)-containing compounds, ammonium decyl ether sulfate, lauramine oxide, sodium alpha olefin sulfonates, lauryl hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, or combinations thereof.

19. The method of claim 11, wherein the treatment composition further comprises a demulsifier.

20. The method of claim 11, wherein the metal concentration is reduced by from about 0.001% to about 10%.
